(19) United States
(12) Patent Application Publication
(10) Pub. No.: US 2026/0205480 A1
(43) Pub. Date: Jul. 16, 2026

(54) CYBER THREAT SCORING BASED ON ANOMALY OF RECIPIENT ADDRESS RECEIVING MESSAGES FROM EXTERNAL SENDER ADDRESSES

(71) Applicant: CrowdStrike, Inc., Sunnyvale, CA (US)

(72) Inventors: Rico Valdez, Albuquerque, NM (US); Daniel W. Brown, Ipswich, MA (US)

(21) Appl. No.: 19/025,665

(22) Filed: Jan. 16, 2025

(51) Int. Cl. H04L 9/40

(52) U.S. Cl. CPC H04L 63/1425; H04L 63/126; H04L 63/1416

(57) ABSTRACT

The present disclosure provides an approach of receiving, at a first timestamp, a message that includes a recipient address and an external sender address. The approach determines a tracking duration based on the first timestamp and a message collection cycle. The approach then computes a cyber threat score based on the tracking duration and a base interval. In turn, the approach sends an alert message to an administrator system based on comparing the cyber threat score to a cyber threshold.

### TECHNICAL FIELD

Aspects of the present disclosure relate to cybersecurity, and more particularly, to an approach of cyber threat scoring based on the anomaly of a recipient address receiving messages from external sender addresses.

### BACKGROUND

Cybersecurity refers to the practice of protecting computer systems, networks, and digital assets from theft, damage, unauthorized access, and various forms of cyber threats. Cyber threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware. Additionally, cyber threats also encompass suspicious activities, such as unusual patterns of network traffic or unauthorized access attempts, which may indicate potential security breaches or weaknesses that need investigation and mitigation.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for cyber threat scoring based on the anomaly of a recipient address receiving messages from external sender addresses, in accordance with some embodiments of the present disclosure.

FIG. 2A is a diagram that illustrates a tracking duration based on the start of a message collection cycle and a timestamp of a received message, in accordance with some embodiments of the present disclosure.

FIG. 2B is a diagram that illustrates an adjusted tracking duration based on a recipient address duration and a timestamp of a received message, in accordance with some embodiments of the present disclosure.

FIG. 2C is a diagram that illustrates adjusted tracking durations based on a start of a message collection cycle and timestamps of received messages, in accordance with some embodiments of the present disclosure.

FIG. 3 is a flow diagram of a method for cyber threat detection based on the anomaly of a recipient address receiving messages from external sender addresses, in accordance with some embodiments of the present disclosure.

FIG. 4 is a flow diagram of a method for cyber threat detection based on the anomaly of a recipient address receiving messages from external sender addresses, in accordance with some embodiments of the present disclosure.

FIG. 5 is a block diagram that illustrates an example system for cyber threat scoring based on the anomaly of a recipient address receiving messages from external sender addresses, in accordance with some embodiments of the present disclosure.

FIG. 6 is a block diagram of an example computing device that may perform one or more of the operations described herein, in accordance with some embodiments of the present disclosure.

### DETAILED DESCRIPTION

Email remains a fundamental component of business communication, enabling the rapid and efficient exchange of information on a global scale. However, this widespread use also introduces significant security vulnerabilities. As email continues to serve as a primary communication medium, it has become a preferred attack vector for cybercriminals aiming to gain unauthorized access to sensitive information and systems. The vast volume of emails exchanged daily, combined with the inherent trust often placed in received messages, renders email an attractive target for malicious actors. Cyber threats exploiting email range from basic spam and phishing attacks to highly sophisticated spear-phishing campaigns designed to deceive even the most vigilant recipients. These attacks can result in severe consequences, including data breaches, financial losses, and reputational damage. Despite advancements in email security technologies, organizations continue to struggle with the evolving tactics of cyber adversaries.

Existing email security solutions typically analyze the content and attributes of messages to determine their maliciousness or undesirability (e.g., spam). However, these systems are generally configured at an organizational level without considering the likelihood that a given email recipient will receive an email from a new external sender address. This likelihood can vary significantly across different roles and departments within the organization. For example, a procurement officer may frequently receive emails from new vendors, whereas a software engineer may rarely receive emails from external sender addresses. This lack of individualized risk assessment can lead to false positives or negatives, thereby compromising the effectiveness of the security measures.

Moreover, by focusing solely on the message content and attributes, a well-crafted email by a skilled attacker can bypass many such filters. Advanced phishing techniques, such as spear-phishing, where the attacker customizes the email to the target, can easily evade traditional content-based filters. These attackers often employ social engineering tactics, making the email appear highly legitimate and relevant to the recipient. Additionally, there is no consideration of subsequent emails from such a sender or domain to others within the organization.

The present disclosure addresses the aforementioned and other deficiencies by enhancing security through the identification of anomalous emails. This disclosure utilizes a statistical approach to assign a cyber threat score to messages from external sender addresses based on the likelihood of a recipient address receiving an email from an external sender. The approach employs sender address, recipient address, and timestamp data to establish a baseline of typical email interactions. Additionally, the approach aggregates emails from the same external sender address when multiple emails are addressed to multiple recipient addresses within a particular timeframe, thereby aiding in the identification of potential coordinated threats.

The present disclosure uses a processing device to receive, at a first timestamp, a message that includes a recipient address and an external sender address (e.g., corresponding to a sender that is external to a firewall of the recipient's organization). The first timestamp, in one embodiment, is marked by a receiving system (e.g., email server). The approach determines a tracking duration based on the first timestamp and a message collection cycle. In one embodiment, the tracking duration is the amount of time between the start of the message collection cycle and the first timestamp. In some embodiments, the message collection cycle corresponds to an amount of time that the recipient address is active. The processing device computes a cyber threat score based on the tracking duration and a base interval. In one embodiment, the base interval enables a determination of zero on a Y log scale axis and normalizes events. As such, the approach may produce a score that is uniform and equally applicable to other types of events, therefore enabling scores from different types of events to be combined. For example, the different types of events may correspond to one or more of an unusual email sender, an unusual city-of-login-origin, an unusual target host of login, an unusual creation of new user, an unusual connection to cloud storage provider, an unusual amount of uploaded data in an hour, and etcetera. The score of each event type is a measure of how unusual each event is relative to other event type activity. In one embodiment the scores area based on a logarithm of the tracking duration and the base interval (log(2)(Tracking Duration/Base Interval). In turn, the processing device sends an alert message to an administrator system based on comparing the cyber threat score to a cyber threshold. In one embodiment, the approach combines other cyber threat scores with the cyber threat score to produce a combined cyber threat score and sends the alert message to the administrator system based on comparing the combined cyber threat score to the cyber threshold.

In one embodiment, computing the cyber threat score is devoid of analyzing content from the message. In one embodiment, the processing device determines a recipient address duration that indicates an amount of time that the recipient address has been valid. The processing device adjusts the tracking duration based on the recipient address duration to produce an adjusted tracking duration. In turn, the processing device utilizes the adjusted tracking duration to compute the cyber threat score.

In one embodiment, the message corresponds to email correspondence event type. The processing device identifies a previous cyber threat score, corresponding to a different event type, that was computed using the base interval. For example, the different event type may be one or more of a city-of-login-origin event type, a target host of login event type, a creation of new user event type, a connection to cloud storage provider event type, an amount of uploaded data in an hour event type, etc. The processing device combines the cyber threat score with the previous cyber threat score to produce a combined cyber threat score, and sends the alert message to the administrator system based on comparing the combined cyber threat score to the cyber threshold.

In one embodiment, the processing device identifies a previous message that includes the recipient address, the external sender address, and a previous timestamp. The processing device adjusts the tracking duration based on the previous timestamp to produce an adjusted tracking duration. In turn, the processing device utilizes the adjusted tracking duration to compute the cyber threat score. In one embodiment, the processing device determines whether the recipient address has received previous messages from different external sender addresses and reduces the cyber threat score in response to determining that the recipient address has received messages from different external sender addresses.

In one embodiment, the processing device determines a domain name corresponding to the external sender address and then adds subsequent messages to the message group that includes the domain name. The processing device computes a group cyber threat score based on the messages in the group, and then sends a subsequent alert message to the administrator system based on comparing the group cyber threat score to the cyber threshold.

As discussed herein, the present disclosure provides an approach that improves the operation of a computer system by enhancing security through the identification of anomalous emails. This approach leverages a statistical approach to score incoming emails based on the likelihood of a recipient address receiving an email from an external sender address, thereby establishing a baseline of typical email interactions. In addition, the present disclosure provides an improvement to the technological field of cybersecurity by prioritizing the detection of anomalous emails based on the anomaly of a recipient address receiving messages from external sender addresses. This method enhances threat detection by correlating anomalous email activity with other suspicious behaviors within the network, providing additional context for security incidents and enabling more effective responses to potential threats.

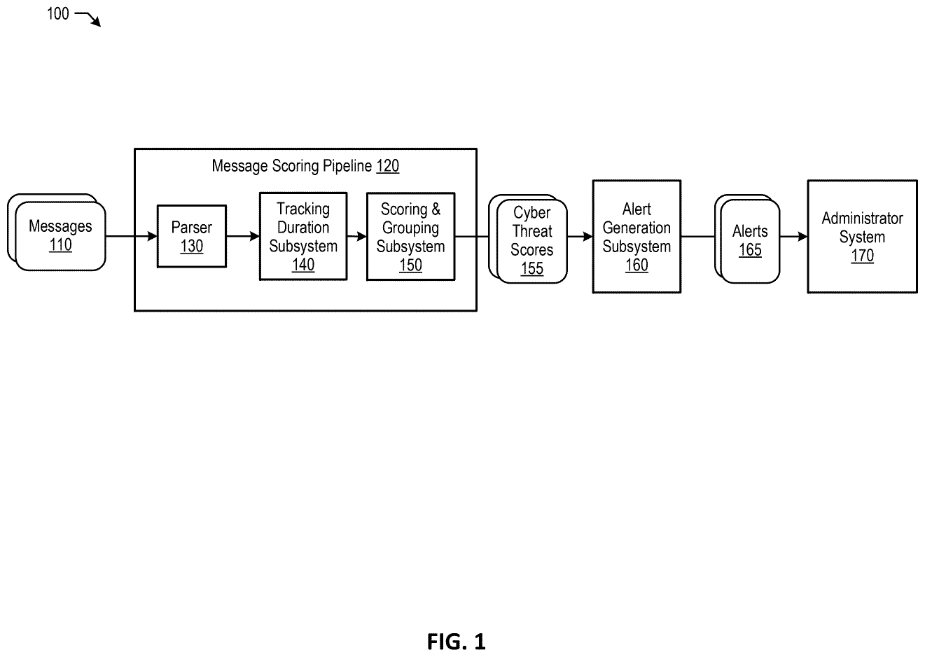

FIG. 1 is a block diagram that illustrates an example system for cyber threat scoring based on the anomaly of a recipient address receiving messages from external sender addresses, in accordance with some embodiments of the present disclosure.

System 100 processes message data including the sender's address, recipient's address, and timestamp to detect anomalies, particularly messages from new or unexpected senders. Unlike traditional email security methods that rely on blacklists to block known malicious domains, system 100 focuses on the relationship between the sender address and recipient address to identify unusual patterns. By analyzing these relationships, system 100 detects messages that deviate from the norm for a particular recipient, thereby flagging potential threats that might otherwise go unnoticed.

System 100 includes message scoring pipeline 120. Message scoring pipeline 120 receives messages 110, which are received from various external senders. Parser 130 extracts data from messages 110, which includes the sender address, recipient address, and a timestamp. In one embodiment, parser 130 processes the raw email data to isolate these key elements, ensuring that the data is in a structured format suitable for further analysis. Parser 130 may also normalize the data to handle variations in message formats from different providers.

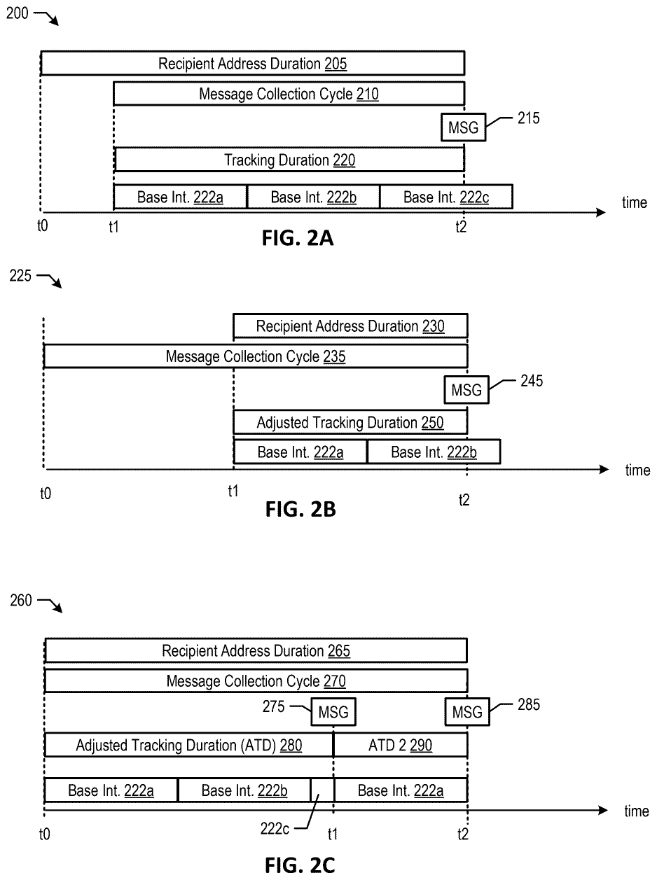

Tracking duration subsystem 140 determines the tracking duration to apply to each message based on, for example, a message collection cycle, a recipient address duration, and previous messages from the external sender address. The collection cycle represents the intervals at which system 100 gathers and processes email data. The recipient address duration represents an amount of time that the recipient address has been valid (see FIGS. 2A-2C and corresponding text for further details).

Scoring and grouping subsystem 150 determines cyber threat scores 155 for messages based on their sender address/recipient address pair anomaly. Scoring and grouping subsystem 150 considers factors such as the frequency of emails from the sender and the time elapsed since the last message. Higher scores are assigned to emails that deviate substantially from the recipient's typical email patterns.

Scoring and grouping subsystem 150 also includes a grouping functionality, which aggregates related emails to identify potential coordinated attacks. When an unusual email is detected and scored highly for its anomaly of a recipient address receiving messages from external sender addresses, scoring and grouping subsystem 150 monitors subsequent emails from the same sender or domain within a configurable period. This grouping allows scoring and grouping subsystem 150 to treat score these emails as a group, providing a comprehensive view of the potential threat. This approach helps in identifying patterns that suggest a coordinated attack, such as phishing campaigns targeting multiple recipients within an organization. By grouping these emails, system 100 can more effectively manage and respond to potential threats.

Scoring and grouping subsystem 150 uses a base interval (e.g., a fixed time interval) to score messages (e.g., six hours, seven hours, one day, etc.). The base interval enables a determination of zero on a Y log scale axis and normalizes events. As such, the approach produces a score that is uniform and equally applicable to other types of events, therefore enabling scores from different types of events to be combined. For example, the different types of events may be one or more of an unusual email sender, an unusual city-of-login-origin, an unusual target host of login, an unusual creation of new user, an unusual connection to cloud storage provider, an unusual amount of uploaded data in an hour, and etcetera. The score of each event type is a measure of how unusual each event is relative to other event type activity.

In one embodiment, scoring and grouping subsystem 150 may perform adjustments to combine scores for different event types that correspond to different base intervals. For example, a first event type may be computed with a base interval of 3 hours and a second event type may be computed with a base interval of 6 hours. In this example, “1” is subtracted from the resulting 3 hour log scores to make it equivalent to having used a 6 hour base interval.

In one embodiment, scoring and grouping subsystem 150 begins recording unique sender and recipient pairs, noting the timestamp of their last occurrence. After system 100 has been operational for over 6 hours (base interval), any pair not observed within this period will receive a small positive score. For example, at t>6 hours, a positive score is determined for sender/recipient pairs not observed for 6 hours, following a logarithmic scale where log₍₂₎(tracking duration/base interval)=cyber score. For example, if a new email is not observed for 12 hours, log₍₂₎(12/6) equals a cyber score of 1. On this logarithmic scale, 24 hours of a tracking duration is log₍₂₎(24/6)=2.

In one embodiment, the tracking duration is based on the prior occurrence of a message from the same external sender address. For example, a repeated email within the 6-hour base interval would receive a low, potentially negative score. In one embodiment, repetitions of interest are grouped within a particular timeframe, extended with further repeats, and the score of each event in the group is locked to the score of the first occurrence. Grouped events are likely to share the same underlying cause and therefore receive the same score. For example, when a new external user sends an email to a new internal recipient, if the email has not been observed previously, the score will be at its maximum, bounded by system 100's operational duration, assumed to exceed the 6-hour base interval. For example, if system 100 has been running for approximately 60 days, the cyber score will be log₍₂₎(60 days*24 hours/6 hours)=7.91. If the email is not observed for another 60 days, it again receives a cyber score of 7.91. However, if the message is received again from the same external sender address 6 hours later, the cyber score is 0 (log₍₂₎(6/6)=0), and if observed 12 hours later, the cyber score is 1 (log₍₂₎(12/6)=1).

In one embodiment, system 100 enhances security by correlating unusual email activity with other suspicious behaviors within the network. For example, if a user receives an unusual email and also exhibits other atypical behaviors, such as accessing a command prompt for the first time, system 100 may correlate these events to raise the overall threat level. This multi-faceted approach allows for a more accurate and timely identification of security threats, enabling quicker responses and reducing the risk of successful attacks. By integrating email anomaly detection with broader network behavior analysis, system 100 provides a robust defense mechanism against sophisticated cyber threats.

Alert generation subsystem 160 receives cyber threat scores 155 and generates alerts 165 to send to administrator system 170 based on comparing the cyber threat scores (individual and group) to a predefined threshold, enabling timely intervention and response to potential threats. Alert generation subsystem 160 ensures that security teams are promptly informed of unusual email activities, allowing them to take appropriate actions to mitigate risks. In one embodiment, alert generation subsystem 160 correlates anomalous activity with other suspicious behaviors within the network, providing additional context for security incidents and enabling more effective responses to potential threats.

In one embodiment, message and scoring pipeline 120 can be integrated with existing email security systems to enhance their capabilities. By providing an additional layer of analysis focused on the unusualness of email interactions, message and scoring pipeline 120 complements traditional content-based filtering mechanisms. In one embodiment, the architecture of message and scoring pipeline 120 is designed to be scalable, allowing it to handle large volumes of email data. Each subsystem may be distributed across multiple servers to ensure efficient processing and analysis, even in environments with high email traffic. In one embodiment, message and scoring pipeline 120 is capable of real-time processing, ensuring that emails are analyzed and scored as they are received. This real-time capability is crucial for timely detection and response to potential threats.

Alert generation subsystem 160 may use cyber threat scores in various embodiments. High scores may indicate that an internal recipient received an unusual email, which is useful when investigating other suspicious activities related to the internal recipient's system or the recipient themselves. For example, an analyst reviewing security events associated with a user, the presence of a suspicious email concurrent with other suspicious activities can quickly highlight the potential for a phishing attack or other email-based threats. This can significantly reduce the time required to understand the context of suspicious activities. Thresholds can be applied to scores to ensure additional context is provided for sufficiently unusual events (measured by time since last observation).

FIGS. 2A, 2B, and 2C are diagrams that illustrate the process of tracking and adjusting the tracking duration for email activities over time, highlighting how message scoring pipeline 120 dynamically adapts to identify unusual email patterns, in accordance with some embodiments of the present disclosure.

FIG. 2A is a diagram that illustrates a tracking duration based on the start of a message collection cycle and a timestamp of a received message, in accordance with some embodiments of the present disclosure.

Diagram 200 includes timestamps t0, t1, and t2. Recipient address duration 205, which is the time at which the recipient address is valid (e.g., time of employment), commences at time t0. Message collection cycle 210 indicates the periodic intervals at which data is collected and analyzed. The collection cycle represents the intervals at which the system gathers and processes email data. Tracking duration 220 is the time between receiving message 215 (first timestamp) and the start of message collection cycle 210 (t1). Base intervals 222 (e.g., 6 hours) are utilized to compute a cyber threat score as discussed herein. As can be seen, tracking duration 220 is as long as base interval 222a, 222b, and a portion of 222c. For example, if the base interval is 6 hours, tracking duration may be 15 hours (less than 3*6 hours), and the cyber threat score of log(2)(15/6) is approximately 1.32.

FIG. 2B is a diagram that illustrates an adjusted tracking duration based on a recipient address duration and a timestamp of a received message, in accordance with some embodiments of the present disclosure. Diagram 225 shows an embodiment of a new recipient address (e.g., new employee) that starts at time t1 (recipient address duration 230). As such, the tracking duration corresponding to message collection cycle 235 is adjusted according to time t1 and the timestamp of message 245 to produce adjusted tracking duration 250. As can be seen, adjusted tracking duration 250 is as long as base interval 222a and a portion of 222b. For example, if the base interval is 6 hours, tracking duration may be 10 hours (less than 2*6 hours), and the cyber threat score of log(2)(10/6) is approximately 0.737.

FIG. 2C is a diagram that illustrates adjusted tracking durations based on a start of a message collection cycle and timestamps of received messages, in accordance with some embodiments of the present disclosure.

Diagram 260 shows an embodiment of a recipient address receiving a previous message 275 from the external sender address and the tracking duration for previous message 275 and new message 285 being adjusted accordingly. Adjusted tracking duration 280 is the time between time t0 (start of message collection cycle 270 or recipient address duration 265, whichever is latest) and t1 (timestamp of message 275). As can be seen, adjusted tracking duration 280 is as long as base interval 222a and a portion of 222b (similar to the computations discussed above regarding FIG. 2A.

Adjusted tracking duration 290 is between time t1 (timestamp of message 275) and time t2 (timestamp of message 285). As can be seen, adjusted tracking duration 290 is as long as base interval 222a and, as such, the cyber threat score of log(2)(6/6) is 0. Adjusted tracking duration 290 produces a lower threat score for message 285 because the time between t1 and t2 is shorter than the time between time t0 and t1.

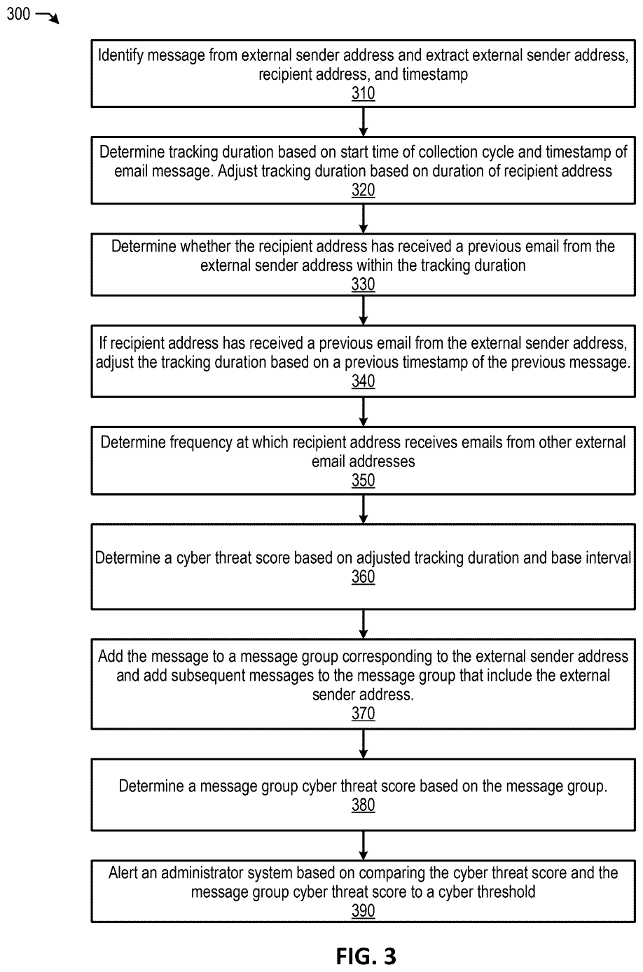

FIG. 3 is a flow diagram of a method 300 for cyber threat detection based on the anomaly of a recipient address receiving messages from external sender addresses, in accordance with some embodiments of the present disclosure.

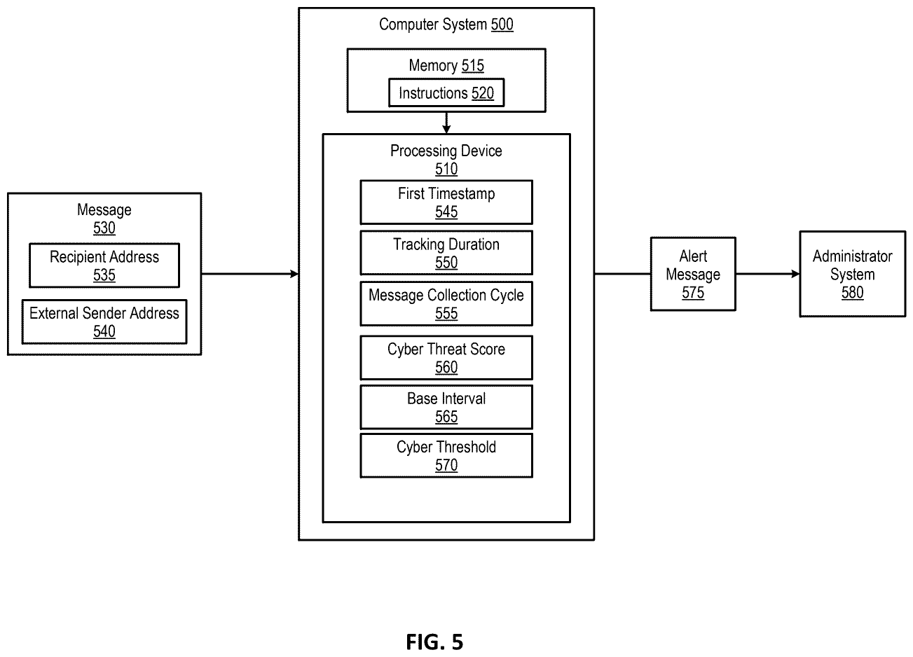

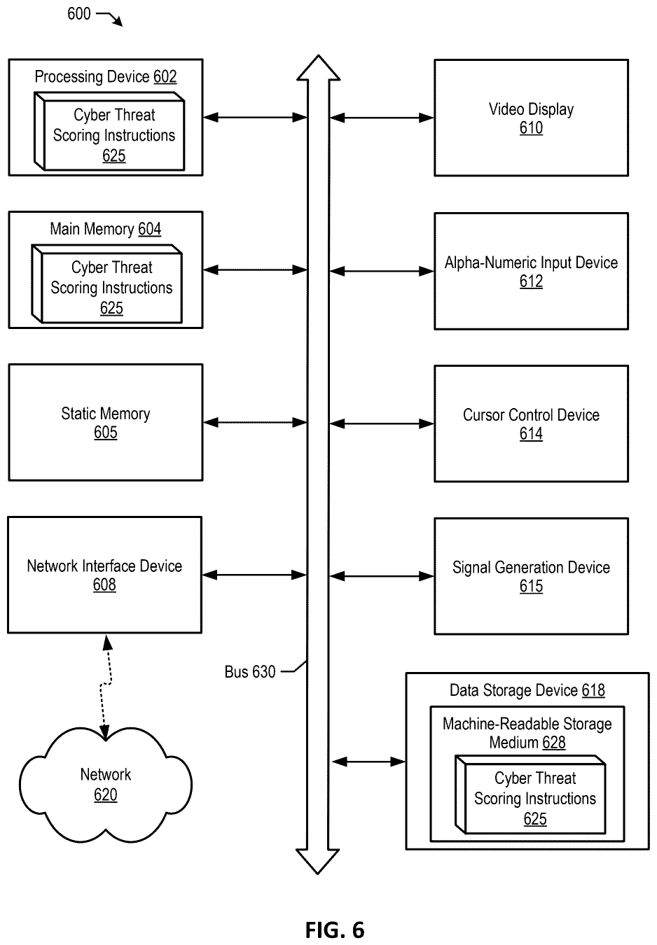

Method 300 may be performed by processing logic that may include hardware (e.g., a processing device), software (e.g., instructions running/executing on a processing device), firmware (e.g., microcode), or a combination thereof. In some embodiments, at least a portion of method 300 may be performed by message scoring pipeline 120 (shown in FIG. 1), processing device 510 (shown in FIG. 5), processing device 602 (shown in FIG. 6), or a combination thereof.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 400 may be performed.

With reference to FIG. 3, method 300 begins at block 310, whereupon processing logic identifies a message from an external sender and extracts the sender's address, recipient's address, and timestamp. At block 320, processing logic determines a tracking duration based on the start time of the collection cycle and the timestamp of the message. The collection cycle is a timeframe of collecting messages, such as over the past 30 days. In one embodiment, the tracking duration is adjusted based on the recipient address duration (e.g., how long the recipient address has been valid), providing a measure of how anomalous the message is for the recipient address (see FIGS. 2A, 2B, and corresponding text for further details).

At block 330, processing logic checks whether the recipient address has received a previous email from the same external sender address within the (adjusted) tracking duration. This step helps in identifying recurring patterns of email interactions. At block 340, if the recipient address received a previous email from the external sender address, processing logic adjusts the tracking duration based on the timestamp of the previous message. This adjustment ensures that the system accurately reflects the frequency of email interactions (see FIG. 2C and corresponding text for further details).

At block 350, processing logic determines a frequency at which the recipient address receives messages from other external senders. This information may used to contextualize the anomalousness of the current message. At block 360, processing logic calculates a cyber threat score based on the adjusted tracking duration and a base interval as discussed herein. In one embodiment, processing logic assigns higher scores to messages that deviate from the recipient's typical message patterns.

At block 370, processing logic adds the message to a message group corresponding to the external sender address, and subsequent messages from the same external sender address are also added to this group. Grouping related emails facilitates identifying coordinated attack patterns. At block 380, processing logic determines a message group cyber threat score based on the current and previous messages from the external sender. This score provides a holistic view of the potential threat posed by the sender. At block 390, processing logic generates an alert for an administrator system based on comparing the cyber threat score or message group cyber threat score to a cyber threshold.

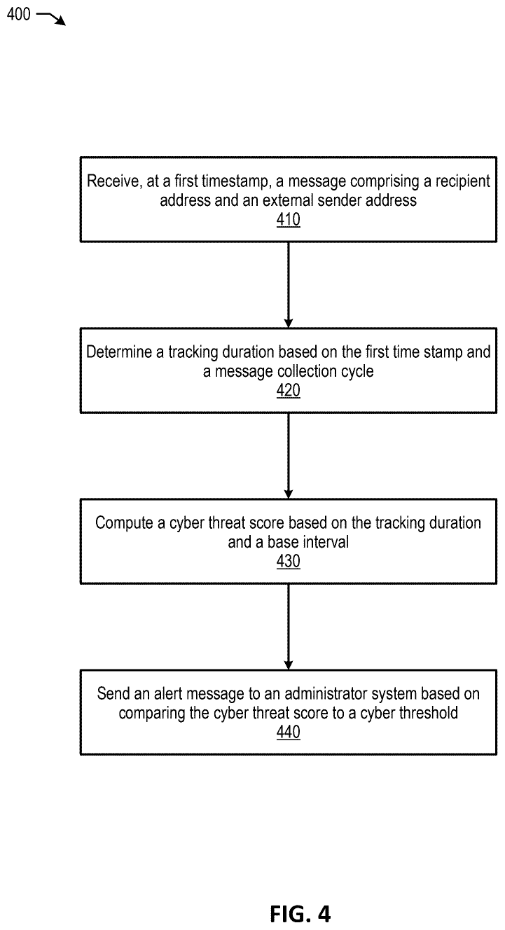

FIG. 4 is a flow diagram of a method 400 for cyber threat detection based on the anomaly of a recipient address receiving messages from external sender addresses, in accordance with some embodiments of the present disclosure.

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by message scoring pipeline 120 (shown in FIG. 1), processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic receives, at a first timestamp, a message comprising a recipient address and an external sender address, which corresponds to a sender that is external to an organization of a recipient corresponding to the recipient address. This step initiates the analysis process.

At block 420, processing logic determines a tracking duration based on the first timestamp and a message collection cycle. At block 430, processing logic computes a cyber threat score based on the tracking duration and a base interval. The threat score reflects the unusualness, or anomalousness, of the recipient receiving a message from the external sender address. At block 440, processing logic sends an alert message to the administrator system based on the computed cyber threat score. Alerts provide critical information for security teams to act upon potential threats.

FIG. 5 is a block diagram that illustrates an example system for cyber threat scoring based on the anomaly of a recipient address receiving messages from external sender addresses, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to receive, at first timestamp 545, a message 530 comprising a recipient address 535 and an external sender address 540. Processing device 510 determines a tracking duration 550 based on the first timestamp 545 and a message collection cycle 555. Processing device 510 then computes a cyber threat score 560 based on the tracking duration 550 and the base interval 565. In turn, processing device 510 sends an alert message 575 to an administrator system 580 based on comparing the cyber threat score 560 to a cyber threshold 570.

FIG. 6 illustrates a diagrammatic representation of a machine in the example form of a computer system 600 within which a set of instructions, for causing the machine to perform any one or more of the methodologies discussed herein for cyber threat scoring based on the anomaly of a recipient address receiving messages from external sender addresses.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute cyber threat scoring instructions 625, for performing the operations and steps discussed herein.

The data storage device 618 may include a machine-readable storage medium 628, on which is stored one or more sets of cyber threat scoring instructions 625 (e.g., software) embodying any one or more of the methodologies of functions described herein. The cyber threat scoring instructions 625 may also reside, completely or at least partially, within the main memory 604 or within the processing device 602 during execution thereof by the computer system 600; the main memory 604 and the processing device 602 also constituting machine-readable storage media. The cyber threat scoring instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “computing,” “sending,” “determining,” “utilizing,” “adjusting,” “identifying,” “reducing,” “adding,” “aggregating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving, at a first timestamp, a message comprising a recipient address and an external sender address;
determining a tracking duration based on the first timestamp and a message collection cycle;
computing, by a processing device, a cyber threat score based on the tracking duration and a base interval; and
sending an alert message to an administrator system based on comparing the cyber threat score to a cyber threshold.

2. The method of claim 1, wherein the computing further comprises computing a logarithm of the tracking duration divided by the base interval.

3. The method of claim 1, wherein the message corresponds to email correspondence event type, the method further comprising:
identifying a previous cyber threat score that was computed using the base interval, wherein the previous cyber threat score corresponds to an event type different from the email correspondence event type;
combining the cyber threat score with the previous cyber threat score to produce a combined cyber threat score; and
sending the alert message to the administrator system based on comparing the combined cyber threat score to the cyber threshold.

4. The method of claim 1, wherein the computing the cyber threat score is devoid of analyzing content from the message.

5. The method of claim 1, further comprising:
determining a recipient address duration that indicates an amount of time that the recipient address has been valid;
adjusting the tracking duration based on the recipient address duration to produce an adjusted tracking duration; and
utilizing the adjusted tracking duration in the computing of the cyber threat score.

6. The method of claim 1, further comprising:
identifying a previous message comprising the recipient address, the external sender address, and a second timestamp;
adjusting the tracking duration based on the second timestamp to produce an adjusted tracking duration; and
utilizing the adjusted tracking duration in the computing of the cyber threat score.

7. The method of claim 1, further comprising:
determining whether the recipient address has received a previous messages from a different external sender address; and
reducing the cyber threat score in response to determining that the recipient address has received the previous messages from the different external sender address.

8. The method of claim 1, further comprising:
determining a domain name corresponding to the external sender address;
adding subsequent messages to a message group that comprise the domain name;
computing a group cyber threat score based on the message and the subsequent messages from the message group; and
sending a subsequent alert message to the administrator system based on comparing the group cyber threat score to the cyber threshold.

9. A system comprising:
a memory; and
a processing device, that is operatively coupled to the memory, to:
receive, at a first timestamp, a message comprising a recipient address and an external sender address;
determine a tracking duration based on the first timestamp and a message collection cycle;
compute a cyber threat score based on the tracking duration and a base interval; and
send an alert message to an administrator system based on comparing the cyber threat score to a cyber threshold.

10. The system of claim 9, wherein the computing further comprises computing a logarithm of the tracking duration divided by the base interval.

11. The system of claim 9, wherein the message corresponds to email correspondence event type, and wherein the processing device is further to:
identify a previous cyber threat score that was computed using the base interval, wherein the previous cyber threat score corresponds to an event type different from the email correspondence event type;
combine the cyber threat score with the previous cyber threat score to produce a combined cyber threat score; and
send the alert message to the administrator system based on comparing the combined cyber threat score to the cyber threshold.

12. The system of claim 9, wherein the computing the cyber threat score is devoid of analyzing content from the message.

13. The system of claim 9, wherein the processing device is further to:
determine a recipient address duration that indicates an amount of time that the recipient address has been valid;
adjust the tracking duration based on the recipient address duration to produce an adjusted tracking duration; and
utilize the adjusted tracking duration in the computing of the cyber threat score.

14. The system of claim 9, wherein the processing device is further to:
identify a previous message comprising the recipient address, the external sender address, and a second timestamp;
adjust the tracking duration based on the second timestamp to produce an adjusted tracking duration; and
utilize the adjusted tracking duration in the computing of the cyber threat score.

15. The system of claim 9, wherein the processing device is further to:
determine whether the recipient address has received a previous messages from a different external sender address; and
reduce the cyber threat score in response to determining that the recipient address has received the previous messages from the different external sender address.

16. The system of claim 9, wherein the processing device is further to:
determine a domain name corresponding to the external sender address;
add subsequent messages to a message group that comprise the domain name;
compute a group cyber threat score based on the message and the subsequent messages from the message group; and
send a subsequent alert message to the administrator system based on comparing the group cyber threat score to the cyber threshold.

17. A non-transitory computer readable medium, storing instructions that, when executed by a processing device, cause the processing device to:
receive, at a first timestamp, a message comprising a recipient address and an external sender address;
determine a tracking duration based on the first timestamp and a message collection cycle;
compute, by the processing device, a cyber threat score based on the tracking duration and a base interval; and
send an alert message to an administrator system based on comparing the cyber threat score to a cyber threshold.

18. The non-transitory computer readable medium of claim 17, wherein the computing further comprises computing a logarithm of the tracking duration divided by the base interval.

19. The non-transitory computer readable medium of claim 17, wherein the message corresponds to email correspondence event type, and wherein the processing device is further to:
identify a previous cyber threat score that was computed using the base interval, wherein the previous cyber threat score corresponds to an event type different from the email correspondence event type;
combine the cyber threat score with the previous cyber threat score to produce a combined cyber threat score; and
send the alert message to the administrator system based on comparing the combined cyber threat score to the cyber threshold.

20. The non-transitory computer readable medium of claim 17, wherein the computing the cyber threat score is devoid of analyzing content from the message.
